(19) United States
(12) Patent Application Publication
(10) Pub. No.: US 2007/0169666 A1
(43) Pub. Date: Jul. 26, 2007

(54) Method for the production of transparent phthalocyanine pigments:

(76) Inventors: Klaus Brychcy, Frankfurt am Main (DE); Joachim Weber, Reinach (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/590,743

(22) PCT Filed: Feb. 2, 2005
(86) PCT No.: PCT/EP05/01020

§ 371 Date: Aug. 25, 2006

(30) Foreign Application Priority Data
Feb. 26, 2004 (DE) 10 2004 009 230.3

(51) Int. Cl. C09D 11/00; C09B 67/50

(52) U.S. Cl. 106/31.78; 106/412; 106/410; 106/413

(57) ABSTRACT

The invention relates to a method for the production of transparent phthalocyanine pigments, characterized in that an eccentric vibratory mill, comprising at least one milling container mounted on vibratory elements and with an energizer unit rigidly mounted to the milling container, is used for the comminution of a raw phthalocyanine pigment, whereby the energizing is carried out eccentrically to one side outside the gravitational axis and the centre of gravity of the milling container such that inhomogeneous vibrations comprising circular, elliptical, and linear vibrations are generated.

The invention relates to a new method of comminuting crude phthalocyanine pigments which uses a vibratory mill having an eccentric vibratory movement.

The comminuting of crude phthalocyanine pigments has been carried out for a long time and requires specific mills. Besides roll mills, vibratory mills are employed, which are characterized by circular, i.e., centric, vibratory movements. In addition, bead mills are employed for wet milling.

The important parameters when constructing a mill are, on the one hand, the specific energy input, i.e., the fraction of energy employed that performs the actual comminuting work, and, on the other hand, the manner in which this specific energy input is applied. The remaining fraction of the energy essentially performs heating.

Thus roll milling or bead milling is indeed characterized by a very gentle energy transfer mechanism; the comminuting work is transferred principally in the form of frictional energy. A disadvantage, however, is the low specific energy input, which necessitates long milling times for a desired fineness.

Vibratory mills do indeed have a substantially higher specific energy input, which is reflected in drastically shorter milling times and hence more economic methods. The energy, however, is transferred principally by impact, and so milling is a long way from being as gentle as in the case of roll milling.

Excessive mechanical stress in the milling of organic pigments may in principle result in irreversible destruction to the crystal lattice, with the consequence of impaired performance properties, such as reduced weatherfastness or reduced color strength, for example. In the case of milling in a vibratory mill, therefore, there exists an optimum in terms of performance properties, and this optimum ought to be reached as quickly as possible.

The synthesis of phthalocyanine pigments has been known for a long time. The phthalocyanines obtained in coarsely crystalline form in the synthesis, and referred to below as crude pigments, have inadequate performance properties which mean that, without comminution, they cannot be used for coloring high molecular mass materials.

The prepigments which form when crude organic pigments are comminuted in roll mills or vibratory mills are distinguished by a primary grain whose particle size distribution is as desired or finer than desired. The primary grains, however, are in such a highly aggregated form that they must first be broken up by an aftertreatment and, if appropriate, converted by means of crystal growth into the desired particle size distribution. For this aftertreatment there are numerous methods known: for example, thermal aftertreatment in a liquid aqueous, organic or aqueous-organic medium, referred to as finishing, or, for example, deaggregation by means of wet dispersion.

The degree of aggregation is dependent on the milling principle used. Thus in the case of roll milling the prepigments which form are commonly less highly aggregated than in the case of vibratory milling. For organic pigments, the aggregation produced by vibratory milling can be so great that it can no longer be reversed by aftertreatment, or can be reversed only at great cost and inconvenience and hence uneconomically.

Milling therefore has a critical influence on the performance properties, such as color strength, cleanness of hue, transparency, gloss, fastness to solvents, light, and weather, and rheology, for example.

DE-A-950 799 discloses a method that uses a vibratory mill for comminuting phthalocyanines.

Gock, E.; Corell, J., Fortschrittsberichte der Deutschen Keramischen Gesellschaft (2001), 16 (1, Symposium—Neue Entwicklungen in der Keramischen Aufbereitung, 1999), 51-59 describes the use of eccentric vibratory mills for preparing a hiding organic pigment. This was not surprising, since for the reasons outlined above it was obvious to suppose that the more efficient milling achieved by an eccentric vibratory mill would lead to even greater aggregation of the pigment particles than on a conventional vibratory mill. This document, however, does not disclose the organic pigment involved.

Against the background of the aspects outlined, the object was to increase the efficiency involved in the milling of phthalocyanines, in order to obtain the abovementioned performance properties in a shorter time or better properties in the same time, and in particular to obtain not only transparent but also strongly colored phthalocyanine pigments.

This object is achieved, surprisingly and contrary to previous experience, through the use of an eccentric vibratory mill.

The invention provides a method for the production of transparent phthalocyanine pigments, which comprises comminuting a crude phthalocyanine pigment using an eccentric vibratory mill having at least one milling container mounted on vibratory elements and having an energizer unit fastened rigidly to the milling container, the energizing taking place eccentrically to one side and outside the gravitational axis and the center of gravity of the milling container, so that inhomogeneous vibrations consisting of circular, elliptical, and linear vibrations are generated.

Suitable mill constructions are described for example in EP-A1-0 653 244. Typical vibration amplitudes are up to 20 mm, the motor speed up to 2000 rpm. The rule here is that the higher the motor speed the lower the vibration amplitude. For example: 12 to 13 mm amplitude at 1000 rpm; 5 to 6 mm amplitude at 1500 rpm. The milling tube diameter can be 200 to 1000 mm, the milling tube length 400 to 2000 mm. The specific drive power is dependent on the desired milling effect. For phthalo blue it is typically between 0.3 to 3.0 kWh/kg of pigment, for “coatings grades” approximately 1.4 kWh/kg of pigment, for example.

The phthalocyanine employed may be a halogenated or halogen-free, metal-free or metal-atom-containing phthalocyanine, as is obtained from the synthesis, for example. Metals can for example be Cu, Fe, Co, Zn, Sn, Cd, Ni, Ti or Al, preference being given to the use of copper phthalocyanine. The phthalocyanine can be substituted by up to 16 halogen atoms, such as chlorine and bromine, for example. The phthalocyanines employed may be present in various phases: for example, alpha, beta, gamma, delta or epsilon. Preference is given to employing copper phthalocyanines which are halogen-free or have only a low chlorine content, up to 6%, for example, especially the copper phthalocyanines obtained from the synthesis in the beta phase. Alpha-phase copper phthalocyanines employed are preferably those having a chlorine content of up to 20%, such as semichlorocopper phthalocyanine, monochlorocopper phthalocyanine or so-called tri-/tetrachlorocopper phthalocyanine.

Examples of phthalocyanine pigments are C.I. Pigment Blue 15, 15:0, 15:1, 15:2, 15:3, 15:4, 15:6, and 16; C.I. Pigment Green 7, 36, and 37.

The crude copper phthalocyanine pigment present directly after the synthesis usually still contains up to about 35% of salts formed during the synthesis. These salts originating from the synthesis are commonly removed by means of alkaline and/or acidic aqueous extraction. In the method of the invention it is possible to employ both the crude pigment containing synthesis salt and the crude pigment purified to remove the synthesis salt.

It is also possible to employ a mixture of different phthalocyanines.

Transparent phthalocyanine pigments are understood as being those which have BET surface areas of more than 20 m²/g, particularly of more than 30 m²/g, especially of more than 40 m²/g, and/or whose particle size distributions as determined by electron microscopy are characterized by D50 values of less than 175 nm, in particular less than 150, especially less than 100 nm.

A simple method which can be used for determining the degree of comminution is the color strength, which increases as the degree of comminution goes up. A further possibility is to select from the X-ray scattering spectrum a suitable peak, whose absolute height is set in relation to the absolute height of the background of the spectrum. The quotient obtained in this way serves as an index of the crystallinity (numerical measure of crystal size and crystal quality) and hence of the degree of pigment milling achieved.

For certain phthalocyanines, grinding brings about transformation from one crystal polymorph into another This is the case, for example, for the milling of beta-phase copper phthalocyanines; in the course of milling, the alpha phase is produced.

Consequently it is also possible to use the degree of transformation from beta to alpha phase, or the fraction of alpha phase produced, as a numerical measure for characterizing the milling step. The determination of the crystal phase takes place likewise by means of X-ray scattering.

In order to be able to compare milling in different mills it is necessary to operate with the same millbase filling level. The millbase filling level is defined as the ratio of the volume of the millbase bed at the beginning of milling (crude pigment and any grinding assistant) to the free volume of the bed of grinding media (only the grinding media). A millbase filling level of around 100% is commonplace. The grinding media filling level must also be the same; it is defined as the ratio of the bed of grinding media to the mill volume. In general a grinding media filling level of 50% to 80% is selected.

In the method of the invention the eccentric vibratory mill can be operated either continuously or batchwise; batchwise operation is preferred on the laboratory scale. It is also possible to connect two or more mills in parallel or in series. Suitable grinding media including all those which are typical, examples being balls, cylinders or rods, and suitable materials for the grinding media include steel, porcelain, ceramic, such as steatite, oxides, such as alumina, unstabilized or stabilized zirconium oxide, mixed oxides, such as zirconium mixed oxides, for example, or quartz. The grinding media ought to have a very smooth and pore-free surface. Milling can take place at temperatures of −20 to +200° C., preferably 0 to 150° C., though it is commonly implemented at a temperature between 20 and 100° C. The mill can also be cooled or heated. The residence time in the mill can be for example between 5 minutes and 25 hours, advantageously between 15 minutes and 15 hours, preferably between 30 minutes and 9 hours.

Suitable interior mill lining includes wear-resistant reinforcements of steel, elastomer or ceramic.

Milling takes place with or without grinding assistants. Suitable grinding assistants include alkali metal salts or alkaline earth metal salts of inorganic acids, hydrochloric acid or sulfuric acid for example, or of organic acids having 1 to 4 carbon atoms, formic acid and acetic acid for example. Preferred salts are sodium formate, sodium acetate, calcium acetate, sodium chloride, potassium chloride, calcium chloride, sodium sulfate, aluminum sulfate or mixtures of these salts. The grinding assistants can be used in any amount, such as in an amount of up to 5 times, relative to the weight of the crude pigment. Larger amounts can also be used, but are uneconomic.

At the milling stage it is possible to employ organic liquids and solvents. Examples of such liquids and solvents are alcohols having 1 to 10 carbon atoms, such as methanol, ethanol, n-propanol, isopropanol, butanols, such as n-butanol, isobutanol, tert-butanol, pentanols, such as n-pentanol, 2-methyl-2-butanol, hexanols, such as 2-methyl-2-pentanol, 3-methyl-3-pentanol, 2-methyl-2-hexanol, 3-ethyl-3-pentanol, octanols, such as 2,4,4-trimethyl-2-pentanol, cyclohexanol; or glycols, such as ethylene glycol, di-, tri- or tetraethylene glycol, propylene glycol, di-, tri- or tetrapropylene glycol, sorbitol or glycerol; polyglycols, such as polyethylene glycols or polypropylene glycols; ethers, such as methyl isobutyl ether, tetrahydrofuran, dimethoxyethane or dioxane; glycol ethers, such as monoalkyl ethers of ethylene glycol or propylene glycol or diethylene glycol monoalkyl ethers, where alkyl can be methyl, ethyl, propyl, and butyl, examples being butyl glycols or methoxybutanol;

polyethylene glycol monomethyl ethers, particularly those having an average molar mass of 350 to 550 g/mol, and polyethylene glycol dimethyl ethers, particularly those having an average molar mass of 250 to 500 g/mol; ketones, such as acetone, diethyl ketone, methyl isobutyl ketone, methyl ethyl ketone or cyclohexanone; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valerolactam or caprolactam; esters, such as carboxylic acid C₁-C₆ alkyl esters, such as butyl formate, ethyl acetate or propyl propionate; or carboxylic acid C₁-C₆ glycol esters; or glycol ether acetates, such as 1-methoxy-2-propyl acetate; or phthalic acid dialkyl esters or benzoic acid alkyl esters, such as benzoic acid C₁-C₄ alkyl esters or C₁-C₁₂ alkyl phthalic acid diesters; cyclic esters, such as caprolactone; nitriles, such as acetonitrile, aliphatic or aromatic amines, such as n-butylamine, dimethylaniline or diethylaniline, for example; unhalogenated or halogenated aliphatic hydrocarbons such as cyclohexane, methylcyclohexane, methylene chloride, carbon tetrachloride, di-, tri- or tetrachloroethylene, di- or tetrachloroethanes; or aromatic hydrocarbons or mixtures of aromatic and aliphatic hydrocarbons such as benzene, benzines or pinene; or alkyl-, alkoxy-, nitro-, cyano-, carboxy- or halogen-substituted aromatic hydrocarbons such as, for example, toluene, xylenes, ethylbenzene, anisole, nitrobenzene, chlorobenzene, dichlorobenzenes; trichlorobenzenes, benzonitrile, benzoic acid or bromobenzene; or other substituted aromatics, such as phenols, aminophenols, cresols, nitrophenols, phenoxyethanol or 2-phenylethanol; aromatic heterocycles, such as pyridine, morpholine, picoline or quinoline;

1,3-dimethyl-2-imidazolidinone; sulfones and sulfoxides, such as dimethyl sulfoxide and sulfolane; and also mixtures of these organic liquids. Preference is given to using those which have crystallizing and/or phase-determining properties. Preference is given to using glycols and glycol ethers, such as ethylene glycol, diethylene glycol or butyl glycol, amines, such as aniline, diethylaniline, dimethylaniline, n-butylamine, o-toluidine or tallow fatty propylenediamine, dimethylformamide, N-methylpyrrolidone, triethanolamine, toluene, xylene, cumene, mesitylene or octylbenzene use.

For the milling it is additionally possible for acids to be employed as well. The acids known from the literature can be used. Preference is given to using phosphoric acid, formic acid, acetic acid, methanesulfonic acid, dodecylbenzene-sulfonic acid, and, in particular, sulfuric acid.

Pulverulent solids are able to absorb a certain amount of liquid without losing their free-flowing consistency. If organic liquids and/or acid are used, it is in amounts such that the millbase retains a dry, i.e., pourable or free-flowing consistency.

Larger amounts lead to caking and cementing of the millbase to the grinding media and to the walls of the mill. The possible maximum amounts of organic liquid and/or acid may vary greatly, and depend on the composition of the millbase and on the resultant fineness and hence on the surface area of the crystallites in the course of milling. Commonly the amounts are below 15% by weight, better below 10% by weight based on crude pigment.

If grinding assistants, organic liquids or acids have been used in the course of the milling, they can be removed prior to an aftertreatment. This is advisable particularly when relatively large amounts of these additives are employed. To perform such removal the millbase is stirred with water to give an aqueous suspension and the additives are dissolved and separated from the prepigment by filtration. With respect to this treatment it has proven appropriate to set an acidic pH by adding acid, hydrochloric acid or sulfuric acid for example. It is also possible to select an alkaline pH, in order, for example, to dissolve an acid that has been used. A further possibility is to dispense with removal, particularly when small amounts of grinding assistants, organic liquids or acids are used. These components may also be dissolved by the water used in the case of finishing, and/or may be neutralized by means of a corresponding amount of base.

In the course of milling in accordance with the method of the invention it is possible to employ further auxiliaries, such as, for example, surfactants, nonpigmentary and pigmentary dispersants, fillers, standardizers, resins, waxes, defoamers, antistats, antidust agents, extenders, shading colorants, preservatives, drying retardants, rheology control additives, wetting agents, antioxidants, UV absorbers, light stabilizers, or a combination thereof.

In accordance with the method of the invention, therefore, it is possible to produce not only phthalocyanine pigments but also phthalocyanine pigment preparations.

Suitable surfactants include anionic or anion-active, cationic or cation-active, and nonionic or amphoteric substances or mixtures of these agents.

Dispersants are added either during actual pigment preparation or else often during incorporation of the pigments into the application media that are to be colored; for example, in the preparation of paints or printing inks, they are added by dispersing the pigments in the corresponding binders.

By pigmentary dispersants are meant pigment dispersants known per se which derive from an organic pigment parent structure and are prepared by chemically modifying that parent structure, examples being saccharin-containing pigment dispersants, piperidyl-containing pigment dispersants, naphthylene- or perylene-derived pigment dispersants, pigment dispersants having functional groups which are attached to the pigment parent structure via a methylene group, pigment parent structures modified chemically with polymers, pigment dispersants containing sulfo acid, sulfonamide or sulfo acid ester groups, pigment dispersants containing ether or thioether groups, or pigment dispersants containing carboxylic acid, carboxylic ester or carboxamide groups. Preference is given to using those pigment dispersants which derive structurally from phthalocyanine as parent structure.

In the method of the invention it is possible to employ one or more pigment dispersants in a total amount of 0.1% to 25% by weight, preferably 0.5% to 20% by weight, in particular 1.0% to 17.5% by weight, based on the weight of the crude pigment.

Fillers and extenders refer to a multiplicity of substances in accordance with DIN 55943 and DIN EN 971-1, examples being the various types of talc, kaolin, mica, dolomite, lime, barium sulfate or titanium dioxide.

It has also proven appropriate to add small amounts of adjuvants from the group of phthalimide, phthalic anhydride, unhydrogenated or hydrogenated wood resin, and glyceryl monooleate in the course of milling.

After the milling the phthalocyanines are frequently in the form of prepigments, whose performance properties do not as yet satisfy the requirements. Therefore, milling is frequently followed by an aftertreatment, which may be, for example, a treatment in a liquid aqueous, aqueous-organic or organic medium, where appropriate at elevated temperature, called a finish hereinbelow, or else may be a wet dispersion. For the aftertreatment it is possible to employ the prepigments directly in dry form or, after removal of the grinding assistants, in dried form, or in presscake form.

In the case of a finish the milled phthalocyanine is subjected to treatment in an aqueous, aqueous-organic or purely organic, one-phase, multiphase or emulsionlike solvent system. Usually, elevated temperatures up to 200° C. are selected, and superatmospheric pressure is employed where appropriate. The treatment may last between 5 minutes and 24 hours; longer times are of course possible but are usually uneconomic.

During the finish or else even during milling it is possible for anionic groups of the nonpigmentary or pigmentary dispersants, surfactants or resins, employed as auxiliaries, to be laked, by means for example of Ca, Mg, Ba, Sr, Mn or Al ions or by means of quaternary ammonium ions, or they are employed already in laked form.

The wet dispersion carried out for the purpose of aftertreatment may take place in the customary batch or continuous roll mills or bead mills, and stirred ball mills with a high energy density can also be employed. Grinding media used are balls, and milling can be carried out in aqueous, aqueous-organic or purely organic, one-phase, multiphase or emulsionlike solvent systems. Here it is possible to employ acids or bases, bases being preferred. The pigment concentration in the millbase is dependent on the rheology of the suspension and on the selected type of mill, and is advantageously not more than 40% by weight of the millbase suspension. Generally temperatures of 0 to 100° C. are selected. The duration of dispersing depends on the desired requirements.

Organic liquids which may be employed for the aftertreatment suitably include the organic liquids recited above in connection with the milling, and mixtures of such liquids. It is preferred to use those which have crystallizing and/or phase-determining properties. Preferred solvents are C₁-C₆ alcohols, especially methanol, ethanol, n- and isopropanol, isobutanol, n- and tert-butanol, and tert-amyl alcohol; C₃-C₆ ketones, especially acetone, methyl ethyl ketone or diethyl ketone; tetrahydrofuran, dioxane, glycols and glycol ethers, such as ethylene glycol, diethylene glycol or ethylene glycol C₃-C₅ alkyl ethers, especially 2-methoxyethanol, 2-ethoxyethanol, butyl glycol, n-butylamine, dimethyl-formamide, dimethylacetamide, N-methylpyrrolidone, benzoic acid C₁-C₄ alkyl esters, toluene, xylene, ethylbenzene, chlorobenzene, o-dichlorobenzene, trichlorobenzenes, nitrobenzene, phenol, nitrophenols, pyridine, quinoline, dimethyl sulfoxide, cyclohexane or methylcyclohexane.

In the case of an aftertreatment it is possible in certain circumstances, especially when using only small amounts of grinding assistants, organic liquids or acids during milling, to forego their removal prior to aftertreatment. In that case the millbase is subjected directly to the aftertreatment, and the grinding assistants, organic liquids or acids are removed using the solvent system employed for the aftertreatment.

In the case of solvents which can be separated from an aqueous phase by steam distillation it is appropriate to remove them in that way prior to isolation, particularly when recovery of the solvent employed is desired.

Other solvents, especially esters, can be destroyed by hydrolysis after the aftertreatment and can be removed relatively easily in that way.

In the case of corresponding performance requirements it is possible for the phthalocyanine pigments or prepigments to be present in the desired form after milling alone, so that they no longer require any further aftertreatment and can be employed directly after milling, or they require merely the above-outlined removal of grinding assistants employed. This is appropriate especially in the case where the phthalocyanine pigments are employed in printing ink systems, since in that case, during the incorporation of the colorant into the printing ink system or into the binder of the printing ink system, it is often possible for an aftertreatment similar to a finish to take place and also, where appropriate, for a desired crystal polymorph to arise.

The millbases produced by the method of the invention have a dry, i.e., pourable, free-flowing consistency; following the removal of the grinding assistants or following the aftertreatment, the prepigments, pigments or pigment preparations are in suspension form and can be isolated by the customary methods, such as by filtration, decanting or centrifuging, for example. Solvents can also be removed by washing. The prepigments, pigments and pigment preparations can be employed as preferably aqueous presscakes, but are generally dried, solid systems of free-flowing, pulverulent consistency, or are granules.

The auxiliaries can also be added only after the milling, at any desired step of the aftertreatment or isolation.

The pigments and pigment preparations produced by the method of the invention can be used for pigmenting high molecular mass organic materials of natural or synthetic origin, such as plastics, resins, varnishes, paints, electrophotographic toners and developers, electret materials, color filters, and also inks, including printing inks, and seed. The implementation of these applications is known for example from DE-A-103 51 580 or PCT/EP 03/13362.

It was surprising and unforeseeable that through the use of a vibratory mill operating with the eccentric vibration principle, counter to the teaching of Gock, E. and Corell, J., it is possible to comminute phthalocyanines in a way which is more economic as compared with conventional vibratory mills, yet still to produce phthalocyanine pigments of high transparency. Also surprising and unforeseeable was the fact that the phthalocyanine pigments produced by the method of the invention also possess, additionally, high gloss, color strength, dispersibility, cleanness of hue, and good rheology. Another surprising finding was that it is possible to carry out grinding with higher quantities of organic solvent than in a conventional vibratory mill, in other words one operating on the centric vibration principle, without instances of caking of the millbase. As a result of the use of the eccentric milling principle, therefore, the range of use of vibratory milling is significantly extended.

The BET surface area is determined in accordance with DIN 66132.

The particle size distribution is determined by means of electron microscopy; 50% by volume of the particles have an average diameter equal to or less than the figure referred to as the D50. The D50 figure is determined by manual evaluation on a graphics tablet. The particles encompassed by this determination are the primary particles.

In order to assess the properties of the pigment preparations in the coatings sector a selection was made, from among the multiplicity of known varnishes, of an aromatics-containing alkyd-melamine resin varnish (AM) based on a medium-oil alkyd resin and on a butanol-etherified melamine resin.

The coloristic properties were determined in accordance with DIN 55986. Following the dilution of the millbase to the final pigment concentration, the viscosity was assessed using the Rossmann viscospatula, type 301 from Erichsen.

Gloss measurements were made on film castings, from an angle of 20° in accordance with DIN 67530 (ASTMD 523), using the “multigloss” gloss meter from Byk-Mallinckrodt.

In the examples which follow, parts and percentages are by weight unless indicated otherwise.

### EXAMPLE 1

A vibratory mill operating on the eccentric vibration principle in accordance with EP-A1-0 653 244 is charged with iron rods as grinding media. The grinding media filling level is 75%. The millbase is composed of crude copper phthalocyanine pigment P.B.15, sodium sulfate, and diethylene glycol in a weight ratio of 5.5:5.5:1.2. The millbase filling level is 80%. Milling is carried out for 90 minutes. The millbase yield is 98% by weight of the millbase employed. The small loss is due to dust development during filling and emptying.

### COMPARATIVE EXAMPLE 2

The experimental conditions of example 1 are applied to a vibratory mill which operates on the conventional, centric vibration principle.

The millbase yield is drastically reduced and is only 2.8% by weight of the millbase employed. The loss is due to caking of the millbase to the iron rods and to the walls, the millbase being so firmly cemented that it has to be chiseled off in order to clean the mill.

### EXAMPLE 3a

A vibratory mill operating on the eccentric vibration principle in accordance with EP-A1-0 653 244 is charged with iron rods as grinding media. The grinding media filling level is 75%. The millbase is composed of crude copper phthalocyanine pigment P.B.15 and sodium sulfate, in a weight ratio of 1:5. The millbase filling level is 95%. Milling is carried out for an hour. The millbase yield is greater than 98% by weight. The small loss is due to the filling and emptying operation.

### EXAMPLE 3b

The millbase from example 3a is desalted by stirring in 4 times the amount of 5% strength by weight sulfuric acid at 90° C. for 2 hours, and the suspension is filtered with suction and the presscake is washed free of salt. The aqueous presscake has a dry-matter content of 33% by weight.

### EXAMPLE 3c

151.7 parts of 33% by weight aqueous presscake produced in accordance with example 3b are stirred in 288 parts of tert-amyl alcohol, 186.3 parts of water, and 8.6 parts of sodium hydroxide. Following the addition of 1.5 parts of 32% by weight copper phthalocyaninesulfonic acid with an average degree of substitution of 1.5 sulfonic acid groups per copper phthalocyanine radical, 8.6 parts of sodium hydroxide, and 2 parts of a rosin modified with maleic anhydride and fumaric acid and having an acid number of approximately 260, the suspension is stirred under superatmospheric pressure at 135° C. for 3 hours. Then the tert-amyl alcohol is distilled off, the suspension is filtered with suction, and the presscake is washed to neutrality and dried. This gives 48.5 parts of phthalocyanine pigment preparation in the beta phase. The BET surface area is 45.5 m²/g.

### COMPARATIVE EXAMPLE 4A/B

The experimental conditions of example 3a are applied to a vibratory mill which operates on the conventional, centric vibration principle. Owing to the absence of solvent there is no caking. The millbase is desalted in accordance with the conditions of example 3b. The aqueous presscake has a dry-matter content of 40% by weight.

### COMPARATIVE EXAMPLE 4C

An aftertreatment in accordance with example 3c is carried out with presscake produced in accordance with comparative example 4A/B.

### COMPARISON OF EXAMPLE 3c WITH COMPARATIVE EXAMPLE 4C

The pigment preparation produced in accordance with example 3c using the eccentric vibratory milling principle exhibits high color strength, transparency, gloss, and low viscosity in the AM varnish.

The table shows the comparison with the pigment preparation from comparative example 4C (conventional vibratory milling principle):

| Example 3c | Comparative example 4C |
|---|---|
| eccentric milling principle | conventional milling principle |
| markedly higher color strength | markedly lower color strength |
| than comparative example 4C | than example 3c |
| Gloss value 44 | Gloss value 29 |
| Viscosity 6.1 sec | Viscosity 7.0 sec |

### EXAMPLE 5

A vibratory mill operating on the eccentric vibration principle in accordance with EP-A1-0 653 244 is charged with iron rods as grinding media. The grinding media filling level is 70%. The millbase is composed of crude synthesis-salt-containing copper phthalocyanine pigment P.B.15 and concentrated sulfuric acid, in a weight ratio of 15.7:1. The millbase filling level is 78%. Milling is carried out for 2 hours.

The millbase yield is greater than 95%. The small loss is due to the filling and emptying operation.

The millbase is desalted by stirring in 4 times the amount of 5% strength by weight sulfuric acid at 90° C. for 2 hours, aid the suspension is filtered with suction and the presscake is washed free of salt.

The presscake is suspended in 3% strength by weight aqueous sodium hydroxide solution and isobutanol (1:1) to give a suspension containing 17% by weight of phthalocyanine. Following addition of 2% by weight of copper phthalocyanine-sulfonic acid, based on phthalocyanine pigment, the suspension is stirred at 130° C. for 3 hours. Then isobutanol is distilled off, the suspension is filtered with suction, and the presscake is washed to neutrality and dried. This gives a phthalocyanine pigment preparation in the beta phase.

### COMPARATIVE EXAMPLE 6

Example 5 is carried out with the sole difference that a vibratory mill operating on the conventional vibrational principle is employed instead of the eccentric mill. The millbase yield is below 60%, due to caking.

### COMPARISON OF EXAMPLE 5 WITH COMPARATIVE EXAMPLE 6

The pigment preparation from example 5 yields transparent colorations with a clean, greenish blue hue, high gloss, and good flow properties in the AM varnish. With a deltaH of −1.6, the hue is substantially greener, and, with a deltaC of 0.7, is somewhat cleaner as compared with comparative example 6; a very green hue is an advantage in the case of beta-phase phthalocyanine pigments.

| Example 5 | Comparative example 6 |
|---|---|
| eccentric milling principle | conventional milling principle |
| significantly higher color strength | significantly lower color strength |
| compared with comparative | compared with example 5 |
| example 6 | |
| markedly more transparent than | markedly more hiding than example 5 |
| comparative example 6 | |
| Gloss value 77 | Gloss value 63 |
| Viscosity 5.2 sec | Viscosity 6.2 sec |
| BET surface area: 80.9 m²/g | BET surface area: 54.4 m²/g |
| Particle size D50: 65 nm | Particle size D50: 109 nm |

1) A method for the production of a transparent phthalocyanine pigment comprising the step of comminuting a crude phthalocyanine pigment using an eccentric vibration mill having at least one milling container mounted on vibratory elements and having an energizer unit fastened rigidly to the milling container, the energizing taking place eccentrically to one side and outside the gravitational axis and the center of gravity of the at least one milling container, so that inhomogeneous vibrations comprising circular, elliptical, and linear vibrations are generated.

2) The method as claimed in claim 1, wherein the crude phthalocyanine pigment is a copper phthalocyanine.

3) The method as claimed in claim 1, wherein the crude phthalocyanine pigment is substituted by up to 16 halogen atoms.

4) The method as claimed in claim 1, wherein the crude phthalocyanine pigment is C.I. Pigment Blue 15, 15:0, 15:1, 15:2, 15:3, 15:4, 15:6 or 16; C.I. Pigment Green 7, 36 or 37.

5) The method as claimed in claim 1, wherein the transparent phthalocyanine pigment has a BET surface area of more than 20 m²/g.

6) The method as claimed in claim 1, wherein said comminuting is carried out at a temperature between 0 and 150° C.

7) The method as claimed in claim 1, wherein the comminuting is carried out in the presence of alkali metal salt or alkaline earth metal salt.

8) The method as claimed in claim 1, wherein the comminuting is carried out in the presence of 0 to 15% by weight, based on the crude phthalocyanine pigment, of organic solvent.

9) The method as claimed in claim 1, wherein the comminuting is carried out in the presence of at least one auxiliary selected from the group consisting of surfactants, dispersants, fillers, standardizers, resins, waxes, defoamers, antistats, antidust agents, extenders, shading colorants, preservatives, drying retardants, rheology control additives, wetting agents, antioxidants, UV absorbers, light stabilizers, and a combination thereof.

10) The method as claimed in claim 1, wherein subsequent to comminuting, the method further comprises solvent finishing.

11) A transparent phthalocyanine pigment made in accordance with the method of claim 1.

12) A pigmented high molecular mass organic material of natural or synthetic origin pigmented by a transparent phthalocyanine pigment as claimed in claim 11.

13) The pigmented high molecular mass organic material of natural or synthetic origin as claimed in claim 12, wherein the pigmented high molecular mass organic material of natural or synthetic origin is in a form selected from the group consisting of plastics, resins, varnishes, paints, electrophotographic toners, electrophotographic developers, electret materials, color filters, inks, printing Inks, and seed.
